(19) United States
(12) Patent Application Publication
(10) Pub. No.: US 2002/0121533 A1
(43) Pub. Date: Sep. 5, 2002

(54) Interior fitting device for a vehicle

(76) Inventor: Horst Plate, Renningen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/076,627

(22) Filed: Feb. 19, 2002

(30) Foreign Application Priority Data
Feb. 16, 2001 (DE) 101 07 286.4

(51) Int. Cl. B60R 7/06; B60R 9/00; B60R 11/00

(52) U.S. Cl. 224/277; 224/483; 224/544

(57) ABSTRACT

An interior fitting device is provided for a vehicle, particularly a motor vehicle, having several adjacent interior fitting devices and having a receiving space with a feeding opening for at least one card-type and/or strip-type flat object. In order to be able to better utilize the available installation space at the interior fitting of the vehicle, it is provided that the receiving space is arranged in a gap which is situated between the interior fitting parts.

### BACKGROUND AND SUMMARY OF THE INVENTION

This application claims the priority of German application 101 07 286.4, filed Feb. 16, 2001, the disclosure of which is expressly incorporated by reference herein.

The invention relates to an interior fitting device for a vehicle having a receiving space with a feeding opening for at least one flat object.

An interior fitting device of the above-mentioned type for a vehicle, particularly a motor vehicle, is known from Japanese Patent Document JP 10-217 860 A. It is arranged in a vehicle occupant compartment and has several mutually adjoining interior fitting parts which are formed, for example, by a center part of a dashboard and by an adjoining covering part of the dashboard. In the center part, a receiving element is arranged which has a feeding opening and a receiving space for at least one flat object, particularly a card, such as a refueling card, a parking receipt or the like. For this purpose, a recess is provided in the center part, into which recess the box-shaped receiving element for the flat object is inserted. In the center part of the dashboard which is within the driver's reach, the receiving element requires installation space which is no longer available for other functioning or operating elements.

It is therefore an object of the invention to provide an interior fitting device of the initially mentioned type into which a receiving space for a flat object can be integrated in a simple manner without requiring installation space in an interior fitting part.

This object is achieved by an interior fitting device wherein the receiving space is arranged in a gap which is present between the interior fitting parts. Additional further developments which advantageously develop the invention are described herein and in the claims.

Advantages achieved by the invention are that the receiving space for the flat object can be provided in the gap existing between the two interior fitting parts. Because of the small thickness of the flat object, the width of the gap is sufficient for this flat object. Without requiring installation space in one of the interior fitting parts, the receiving space can nevertheless be arranged within the driver's reach or within the reach of another occupant. In addition, the manufacturing and tool costs for the arrangement of the interior fittings are reduced because no separate recess for the receiving space must be provided in one of the interior fitting parts.

According to certain preferred embodiments, it is advantageous that the flat object is securely held in the receiving space.

In certain preferred embodiments, it is advantageously possible to securely hold flat objects—also of different thicknesses—in the receiving space, by utilizing elastically deforming friction lining in the receiving space.

According to a further development of certain preferred embodiments of the invention, receiving space forms and interior door covering section arranged in a region of a window or door opening 9 with such an arrangement it is particularly advantageously achieved that, when the driver leaves the vehicle, his attention is drawn to the object inserted in the receiving space and it is avoided that this object is unintentionally left in the vehicle.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic sectional view of an interior fitting device having a receiving space for a flat object, constructed according to a first preferred embodiment of the invention;

FIG. 2 is a schematic view of a second embodiment of an interior fitting device according to the invention;

FIG. 3 is a sectional view along line III-III of the interior fitting device according to FIG. 2;

FIG. 4 is a view of a third embodiment of an interior fitting device according to the invention; and

FIG. 5 is a view of a receiving element having a receiving space for a flat object, constructed according to preferred embodiments of the present invention.

### DETAILED DESCRIPTION OF THE PREFERRED EMBODIMENT

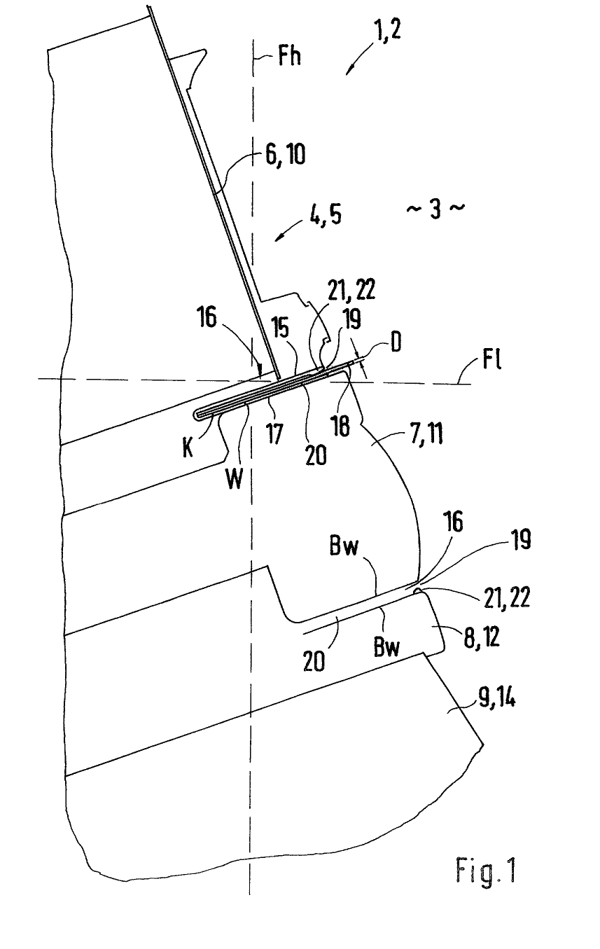

FIG. 1 is a partial sectional view of a center part 1 of a dashboard 2 of a vehicle, particularly a passenger car. The vertical axis Fh of the vehicle and the longitudinal axis F1 of the vehicle are situated in the sectional plane. The dashboard 2 is arranged in an occupant compartment 3 of the vehicle and is therefore a component of the interior fitting 4 which therefore has at least one interior fitting device 5, which—according to FIG. 1—may be formed by the center part 1. The interior fitting device 5 comprises at least two mutually adjoining interior fitting parts 6 and 7 which may be arranged side-by-side or above one another and, in the embodiment shown, form components of the center part 1. According to the equipment of the vehicle, additional interior fitting parts 8 and/or 9 may be provided which may be arranged side-by-side, above or below the other interior fitting parts 6 and 7 respectively.

The interior fitting parts 6 to 9 may be safety or function modules, covering or operating elements, such as switches or the like, trays, storage spaces or other interior fitting components.

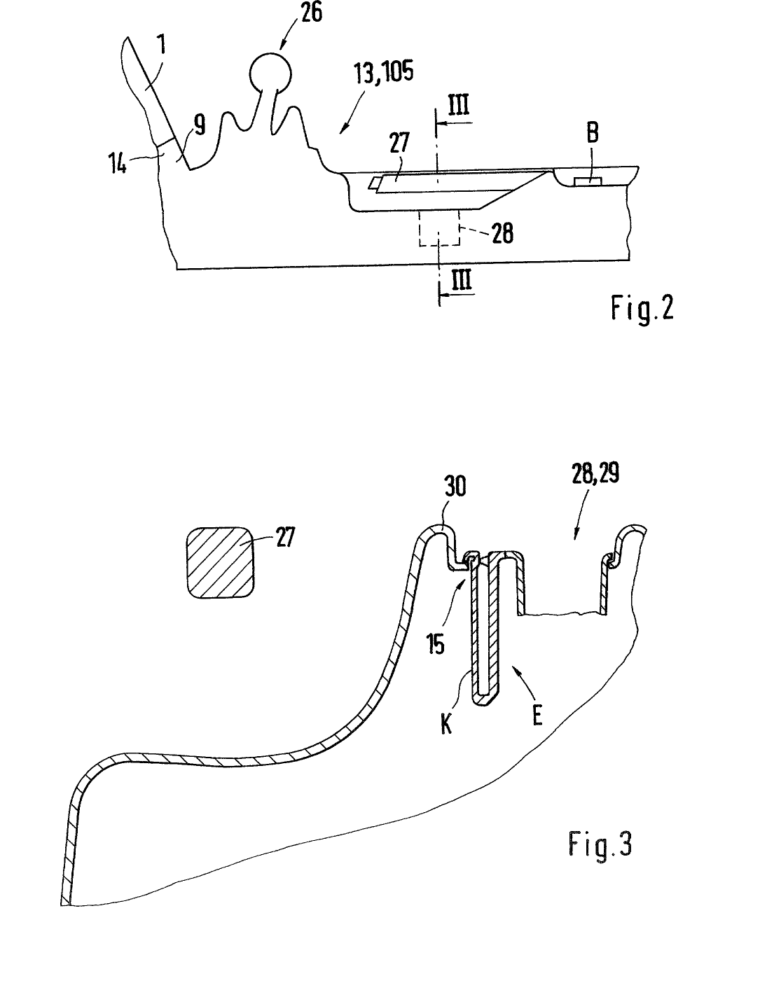

The interior fitting part 6 may be formed by an operating part 10 of an audio system or of an onboard computer or the like. The interior fitting part 7 may, for example, be an operating element 11, particularly for a heating/air-conditioning unit. The interior fitting part 8 is constructed as a tray 12, and the interior fitting part 9 is constructed as a connection part to a center console 13 (FIG. 2) arranged between two vehicle seats not illustrated here, or it adjoins the center console 13.

The interior fitting 4 may be such that it can be assembled in a module-type manner of the interior fitting parts. One of the interior fitting parts 6, 7, 8 or 9 is arranged at a narrow distance from an adjoining other interior fitting part 6, 7, 8 or 9, so that a gap 15 exists between the interior fitting parts, and thus a space 16 is formed into which a receiving element 17 can be inserted for at least one flat object 18. The receiving element 17 has a feeding opening 19 for the object 18. The feeding opening 19 is preferably situated within the reach of an occupant in the vehicle occupant compartment 3. The, particularly card-type or strip-type flat object 18 —in comparison to its surface size —has a narrow thickness D and is, for example, a refuelling or credit card, a parking receipt, a road map or an inspection booklet of the vehicle or the like. So that the object is held securely but removably in a receiving space 20, the latter has a holding element 21. The holding element 21 is preferably constructed in an elastically springy or deformable manner, so that it presses the object 18 against an interior wall W of the receiving space 20 and thus holds this object in a clamping manner, According to a first embodiment, the receiving space 20 may be surrounded by an insertion part E which can be inserted into the space 16, which insertion part can be implemented as a box K which may form the receiving element 17. The insertion part E or the box K is open on at least one side and thus forms the feeding opening 19. According to a second embodiment, the receiving space 20 with its feeding opening is formed by the space 16 which is open at the edge. The interior wall W of the receiving space 20 is therefore formed of boundary walls Bw of the adjacent interior fitting parts 7 and 8. The holding element 21 may be fastened on one of these boundary walls Bw.

In a preferred embodiment, the holding element 21 is formed by a friction lining 22 which is situated on the interior wall W in the area of the feeding opening 19. The friction lining may be present in a punctiform or strip-shaped manner and may extend at least in regions around the feeding opening. It is preferably implemented as a rubber lip.

The depth T (FIG. 5) of the receiving space 20 is preferably dimensioned such that flat objects of the conventional card format are only partially received therein, so that the object 18 projects slightly out of the feeding opening 19, as clearly illustrated in FIG. 1. The width of the receiving space 20 measured transversely to the depth T is preferably adapted to the conventional card format.

As illustrated in FIG. 5, the friction lining 22 may, however, also be arranged on a holding element which has a web-type or strip-type tension clip 131 which is preferably constructed in an elastically springy manner and carries the friction lining 22 on its free end. In a preferred embodiment, the free end 132 is situated in the area of the feeding opening 19. The tension clip 131 therefore presses the friction lining 22 onto the object 18. As an addition or an alternative, the friction lining can rest on the interior wall W. The tension clip will then press the object onto the friction lining. The tension clip and the box K may be constructed in one piece.

The insertion part E or the box K has side walls 23 forming the interior wall W as well as a bottom 24. A covering section 25 extending away from the feeding opening 19 may start at the free end of at least one side wall 23, which covering section 25, after the insertion in the space of the receiving element 17, 117, which can be constructed as the insertion part E, closes off flush with the interior fitting part 6, 7, 8 or 9 or slightly overlaps the interior fitting part.

On the center console 13 illustrated in FIG. 2, a transmission shifting device 26 and an operating element 27 for a manually operable parking brake can be arranged. The center console 13 forming an interior fitting device 105 also has a tray 28 which may be arranged next to the operating device 27, as illustrated particularly in FIG. 3. The tray 28 forms an interior fitting part 29 of the interior fitting device 105. Another interior fitting part 30 is the housing of the center console 13. The gap 15 is situated between the interior fitting parts 29 and 30, into which gap 15, at least one of the receiving elements 17 and 117 respectively can be inserted.

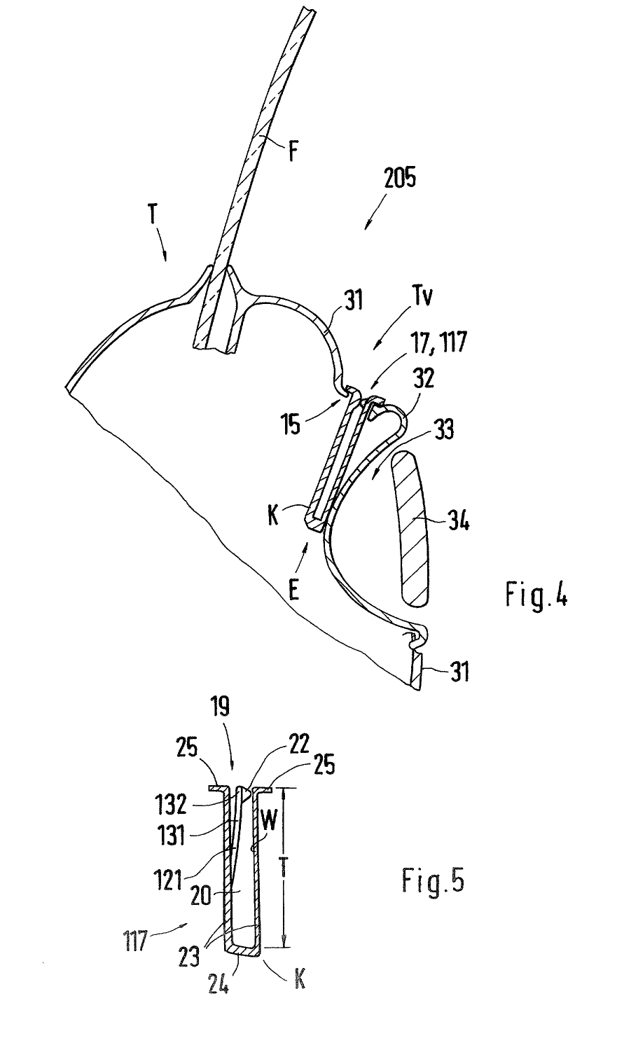

FIG. 4 illustrates another embodiment of an interior fitting part 205. It forms the interior door covering Tv and, as an interior fitting part 31, may have an interior covering of the door, and may have a recessed grip 33 as an interior fitting part 32 adjoining the interior covering or inserted therein, in which recessed grip 33 an operating device 34 for the door opening is arranged. Between the interior fitting parts 31 and 32, the gap 15 is formed into which at least one of the receiving elements 117 and 17 respectively can be inserted. The receiving space 20 is therefore arranged within the region of the door opener 34 so that, when opening the door from the inside, an occupant's attention is drawn to a flat object 18 which may possibly be arranged in the receiving space 20. However, it would also be conceivable to arrange the receiving element 17 and 117 respectively between an operating element B (FIG. 2) for the window F (FIG. 4) and the interior fitting part 29, in which case, the operating element B may, for example, be an electric switch of a window lifting device. As an alternative, this switch could be mounted on the interior covering Tv of the door.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Interior fitting device for a passenger motor vehicle, having several adjacent interior fitting parts and having a receiving space with a feeding opening for at least one flat object, wherein the receiving space is arranged in a gap which is present between the interior fitting parts.

2. Interior fitting device according to claim 1, wherein the receiving space has a holding element which holds the flat object in a clamping manner.

3. Interior fitting device according to claim 2, wherein the holding element includes a friction lining.

4. Interior fitting device according to claim 3, wherein the friction lining is elastically deformable.

5. Interior fitting device according to claim 1, wherein the receiving space is formed by a space with an open edge which is present between two interior fitting parts.

6. Interior fitting device according to claim 2, wherein the receiving space is formed by a space with an open edge which is present between two interior fitting parts.

7. Interior fitting device according to claim 3, wherein the receiving space is formed by a space with an open edge which is present between two interior fitting parts.

8. Interior fitting device according to claim 7, wherein the friction lining is elastically deformable.

9. Interior fitting device according to claim 1, wherein the receiving space is constructed in a receiving element which is constructed as an insertion part (E) which can be inserted into the gap and has the feeding opening.

10. Interior fitting device according to claim 2, wherein the receiving space is constructed in a receiving element which is constructed as an insertion part (E) which can be inserted into the gap and has the feeding opening.

11. Interior fitting device according to claim 3, wherein the receiving space is constructed in a receiving element which is constructed as an insertion part (E) which can be inserted into the gap and has the feeding opening.

12. Interior fitting device according to claim 5, wherein the receiving space is constructed in a receiving element which is constructed as an insertion part (E) which can be inserted into the gap and has the feeding opening.

13. Interior fitting device according to claim 1, wherein in a region of the feeding opening, a friction lining is arranged in regions or in a surrounding manner.

14. Interior fitting device according to claim 3, wherein the friction lining is formed by a rubber lip.

15. Interior fitting device according to claim 7, wherein the friction lining is formed by a rubber lip.

16. Interior fitting device according to claim 2, wherein the holding element comprises a tension clip which holds the object in the receiving space in an elastically springy manner, and wherein the tension clip has a free end which faces the feeding opening.

17. Interior fitting device according to claim 16, wherein a friction lining is constructed at the free end.

18. Interior fitting device according to claim 1, wherein the gap is at a vehicle center console.

19. Interior fitting device according to claim 1. Wherein the gap is at an interior fitting of the vehicle arranged between two seats, or a part of a center console.

20. Interior fitting device according to claim 1, wherein the gap is at an interior door covering (Tv) of the vehicle or a part of the door covering, and wherein the receiving element is arranged in a region of a door opener or of a window operating device (B).

21. Interior fitting device according to claim 1, wherein the fitting device is a component of a dashboard of the vehicle and preferably forms a center part of the dashboard.

22. A passenger vehicle assembly comprising:
a first vehicle interior part,
a second vehicle interior part disposed adjacent to the first part with a gap between said first and second parts, and
receiving means disposed in said gap which is operable to detachably receive a flat object.

23. An assembly according to claim 22, wherein said receiving means includes a holding element operable to clamp the flat object.

24. An assembly according to claim 23, wherein the holding element includes a friction lining.

25. An assembly according to claim 24, wherein the friction lining is elastically deformable.

26. An assembly according to claim 22, wherein the first and second vehicle interior parts are disposed at a vehicle dashboard.

27. An assembly according to claim 22, wherein the first and second vehicle interior parts are disposed at a vehicle center console.

28. An assembly according to claim 22, wherein the first and second vehicle interior parts are disposed at a vehicle side door.

29. An assembly according to claim 23, wherein said holding element has a feeding opening at one end facing a vehicle interior passenger space and an end member at an opposite end for limiting an insertion depth of a flat object in said holding element.

30. An assembly according to claim 29, wherein said receiving means includes a holding element operable to clamp the flat object.

31. An assembly according to claim 30, wherein the holding element includes a friction lining.

32. An assembly according to claim 29, wherein the friction lining (22) is elastically deformable.

33. An assembly according to claim 29, wherein the first and second vehicle interior parts are disposed at a vehicle dashboard.

34. An assembly according to claim 29, wherein the first and second vehicle interior parts are disposed at a vehicle center console.
